(19) United States
(12) Patent Application Publication
(10) Pub. No.: US 2023/0246706 A1
(43) Pub. Date: Aug. 3, 2023

(54) ACARS REPORT COMMUNICATION SYSTEM

(71) Applicant: SAFRAN AIRCRAFT ENGINES, Paris (FR)

(72) Inventors: Guillaume Rémi BONNET, MOISSY-CRAMAYEL (FR); Josselin Xavier COUPARD, MOISSY-CRAMAYEL (FR); Thomas Louis Gaston DUMARGUE, MOISSY-CRAMAYEL (FR)

(73) Assignee: SAFRAN AIRCRAFT ENGINES, Paris (FR)

(21) Appl. No.: 18/004,927

(22) PCT Filed: Jun. 25, 2021
(86) PCT No.: PCT/FR2021/051175

§ 371 Date: Jan. 10, 2023

(30) Foreign Application Priority Data
Jul. 10, 2020 (FR) 2007333

(51) Int. Cl. H04B 7/185

(52) U.S. Cl. CPC H04B 7/18506

(57) ABSTRACT

Architecture for collecting and transmitting an aircraft flight data report including at least one data acquisition unit installed on board the aircraft, means for transmitting the flight data report installed on board the aircraft and a station for collecting the data report on the ground, including means for calculating and taking into account a cost index for optimizing a choice of a best means for transmitting the flight data report and its content with respect to the cost index.

### TECHNICAL FIELD

The invention relates, in general, to the communication systems present between an aircraft and a support device on the ground.

A use of the invention of particular interest relates to the sending of an ACARS report from an aircraft to the ground at lesser cost.

However, the invention also applies to any other communication system that can use various types of communication channels or protocols.

### PRIOR ART

The ACARS (Aircraft Communication Addressing and Reporting System) report is a system for encoded communications between an aircraft and a station on the ground. It is a report of flight data sent automatically from an aircraft to a maintenance centre on the ground. Thus, the state of the aircraft and in particular the state of the engines is notified to the maintenance centre even before the aircraft has arrived in order to prepare the possible servicing to be carried out.

The data transmitted also relates to other entities, for example air traffic control organisms and airlines. A network of transceivers managed by a central computer is tasked with transferring each piece of information to the correct recipient.

The information transmitted in the ACARS report is sent at predefined moments, at regular intervals or, for example, when a technical anomaly is detected. The content of the report is set in an ACMS (Aircraft Condition Monitoring System) monitoring system and is not modified according to the moment of sending of the report.

The communication of ACARS reports can be carried out with various communication channels and protocols. High-frequency transmissions were used in the past, progressively replaced by very high frequencies (approximately a hundred megahertz). These very high frequencies are now supported by satellite links.

The communication of these reports has, however, a rather high cost due to the communication systems used and the quantity of information sent at each report. The cost is set by contract and can for example be approximately 30 dollars per flight. As the reports go by, duplicates appear and participate in increasing the cost of sending these reports. Moreover, the volume of data sent increases from generation to generation of engines and of aircraft. No supervision is carried out to take advantage of the best way to send the data, while costs that can reach sums of approximately a hundred thousand dollars per month for about twenty engines have been observed.

### DISCLOSURE OF THE INVENTION

The goal of the present invention is therefore to overcome the disadvantages of the aforementioned system and to reduce the cost of sending the ACARS reports for an aircraft.

The object of the invention is therefore an architecture for collecting and transmitting a flight data report of an aircraft comprising at least one data acquisition unit installed on board the aircraft, means for transmitting the data report installed on board the aircraft and a station for collecting the data report on the ground.

This collection and transmission architecture comprises means for calculating and taking into account a cost index for optimising the choice of the best means for transmitting the data report and its content according to the value of the cost index.

Thus, the ACARS report can be dynamic in terms of content and in terms of transmission means. If the cost of transmission is too high since the satellite link is the only possible transmission means, it is possible to reduce the quantity of information contained in the report. If the cost of transmission is not high, for example because of a Wi-Fi network, this network is preferred and allows to send more content.

Advantageously, the architecture comprises means for bidirectional transmission of data between the engines of the aircraft and the means for transmitting the data report of the aircraft.

Advantageously, the means for transmitting the data report are units allowing to send the data report by various communication channels and protocols.

According to one embodiment, the aircraft comprises a unit for collecting messages coming from the station for collecting data on the ground and the station for collecting data on the ground comprises means for sending a message to the unit for collecting messages of the aircraft in order to request to receive more data from the aircraft.

Advantageously, the cost index is determined on the basis of factors that comprise the time of transmission of the data from the aircraft, the cost of transmission of the data from the aircraft, the contractual time remaining for making available the data of the aircraft, and the gain associated with making available the data of the aircraft.

Advantageously, the optimisation of the choice of the best means for transmitting the data report and its content involves avoiding redundancy of information and not being limited to predefined report formats.

The object of the invention is also a method for collecting and transmitting a flight data report of an aircraft comprising at least one data acquisition unit installed on board the aircraft, means for transmitting the data report installed on board the aircraft and a station for collecting the data report on the ground, and comprises the following steps:
Taking into account a calculation of a cost index for the choice of the best means for transmitting the data report and its content according to the value of the cost index; and
Sending when necessary this optimised data report from the aircraft to the station for collecting data on the ground.

Advantageously, the method comprises a step of requesting sending of additional data from the aircraft, said request being received by a unit for collecting messages coming from the ground placed in the aircraft and said request coming from means for sending a message to the unit for collecting messages of the aircraft, means placed in the station for collecting data on the ground.

The object of the invention is also a computer program configured to implement the above method, when it is executed by the computer. The object of the invention is also a recording medium readable by computer comprising instructions that, when they are executed by a computer, lead the latter to implement the above method.

### BRIEF DESCRIPTION OF THE DRAWINGS

Other goals, features and advantages of the invention will appear upon reading the following description, given only as a non-limiting example, and made in reference to the appended drawings in which:

FIG. 1 illustrates a first embodiment of the invention with a single-stream architecture;

FIG. 2 illustrates a first implementation of a method according to the invention with a single-stream architecture;

FIG. 3 illustrates a second embodiment of the invention with a bidirectional architecture; and

FIG. 4 illustrates a second implementation of a method according to the invention with a bidirectional architecture.

### DETAILED DISCLOSURE OF AT LEAST ONE EMBODIMENT

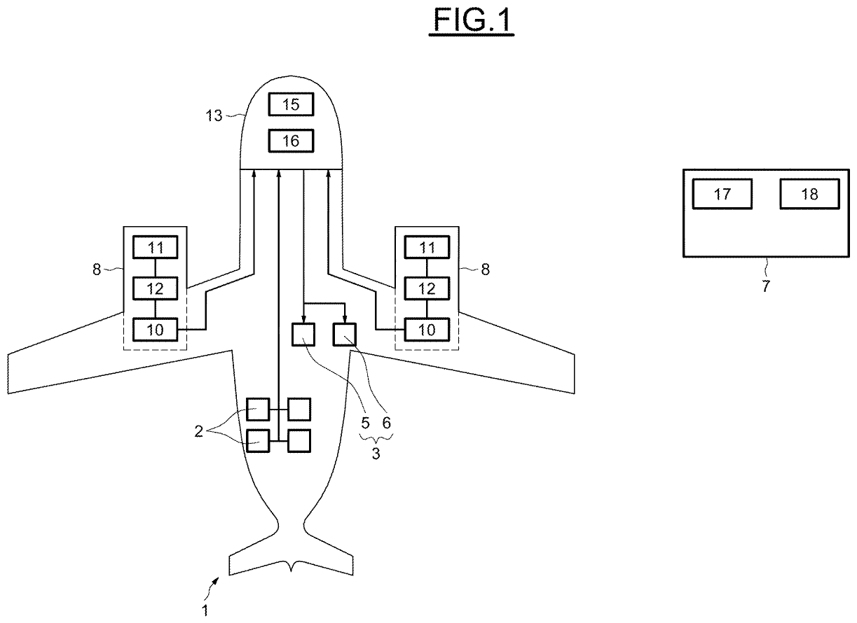

FIG. 1 shows a diagram of an aircraft 1 and of its means for transmitting data reports.

The aircraft 1 is equipped with data acquisition units 2, with means 3 for transmissions of data reports including means 5 for paid transmissions of data reports, for example by satellite, and means 6 for transmitting data reports at low altitude and at a lower cost. The means 6 for transmitting at low altitude are for example means using Wi-Fi, 3G, 4G or 5G networks, the costs of which are lower than the transmissions by satellite. Other communication protocols can also be used.

The means 3 for transmitting data reports are means allowing to transmit these reports to a collection station 7 on the ground.

The data acquisition units 2 have the role of acquiring the data to be transmitted and to integrate it into a data report, for example an ACARS data report. This is for example a unit for acquiring the GPS coordinates of the aircraft, a unit for acquiring pressure and temperature as well as for acquiring operating characteristics or performance of the equipment of the aircraft. This data comes from units or sensors ensuring the monitoring of each piece of equipment.

The aircraft includes for example, for each of the two engines 8, a FADEC (Full Authority Digital Engine Control) unit 10, a unit 11 for acquiring the data of the engine, and a means 12 for transmitting this monitoring data to the engine.

In a specific embodiment of the invention visible in FIG. 1, the means 12 for transmitting this data transmits the monitoring data of the engine to the means 3 for transmitting data reports of the aircraft 1.

In another specific embodiment of the invention, the means 12 for transmitting this engine data is a means 3 for transmitting data reports of the aircraft and directly transmits the engine data to the station 7 on the ground.

The FADEC unit 10 is a system that interfaces itself between the cockpit 13, which comprises the onboard computer 15, and the engines 8 of the aircraft 1 and allows to control the use of the engines 8 and to measure the parameters useful for this control.

With a view to sending the ACARS data report to the station on the ground 7, the aircraft 1 comprises means 16 for calculating and taking into account a cost index for optimising the choice of the best means for transmission of the data report and of its content according to the value of this cost index. These calculation means 16 are for example placed in the cockpit 13.

These means 16 allow to generate a dynamic data report, the content and the means for transmissions of the data report of which vary according to the cost index.

During an event triggering a need to send an ACARS report to the collection station 7 on the ground, the data acquisition units 2 and 11 ensure the acquisition of data, of sometimes significant sizes in octets.

The cost index takes into account the time Tt of transmission of the data from the aircraft 1 to the station 7 on the ground, the cost of transmission C of the data from the aircraft, the contractual time Tc remaining for making available the data of the aircraft, and the gain G associated with making available the data of the aircraft. Thus, the cost index is calculated as follows:

$$Cost index = \frac{Tt}{Tc} \times \frac{G}{C}$$

The ratio between the transmission time Tt and the contractual time Tc allows to know the remaining bandwidth according to the type of contract and the gain G reflects the necessity of making available the data. Thus, a very significant gain is assigned to an alert message indicating that the aircraft cannot carry out a new flight without a maintenance operation. A message associated with a high gain is emitted with priority if the bandwidth does not allow to send it simultaneously with other messages having a lower gain, such as messages of failure of components.

The messages with a lower gain are thus sent only if the sending cost and the bandwidth allow it. For example, the messages for monitoring trends or mission have a low gain and are not emitted in flight, unless the cost of the transmission means is low.

This system allows to renegotiate the contracts and reduce the cost thereof approximately 75% since, according to this cost index, calculated for each message of a data report, the quantities of data sent are optimised. The ACARS reports are not therefore limited to predefined report formats and avoid redundancies of information.

The ACARS reports are received by the collection station 7 on the ground. This station comprises a system 17 for supporting the engine and a device 18 for storing the data.

The support system 17 is intended to prepare the maintenance of the aircraft that will be carried out when the aircraft lands or to organise remote maintenance when the aircraft is in flight.

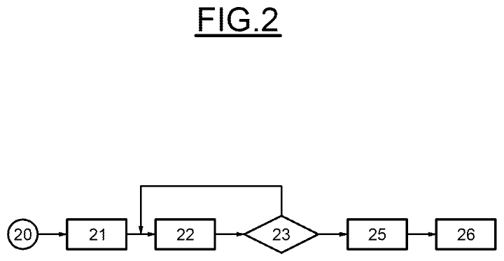

FIG. 2 shows the main steps of a method for collecting and transmitting a flight data report of an aircraft for a single-stream architecture.

According to this single-stream architecture, the information is only transmitted from the aircraft to the station on the ground.

First of all, the need for sending a data report, ACARS or other, is triggered by an event 20. This event is for example generated automatically or occurs after the presence of an anomaly.

The first step 21 of the method is a step of acquiring and recording the data to be transmitted. This data comprises in particular operating data of the engines.

During the following step 22, the calculation of the cost index for each piece of data and for each available transmission means is carried out. The cost index is compared to threshold values (step 23).

If the cost index is lower than a threshold value and is considered to be favourable to sending, during the following step 25, this data report is transmitted to the station on the ground. If this is not the case, the cost index is recalculated.

Finally, during the following step 26, the collection station on the ground receives the data, stores it and processes it.

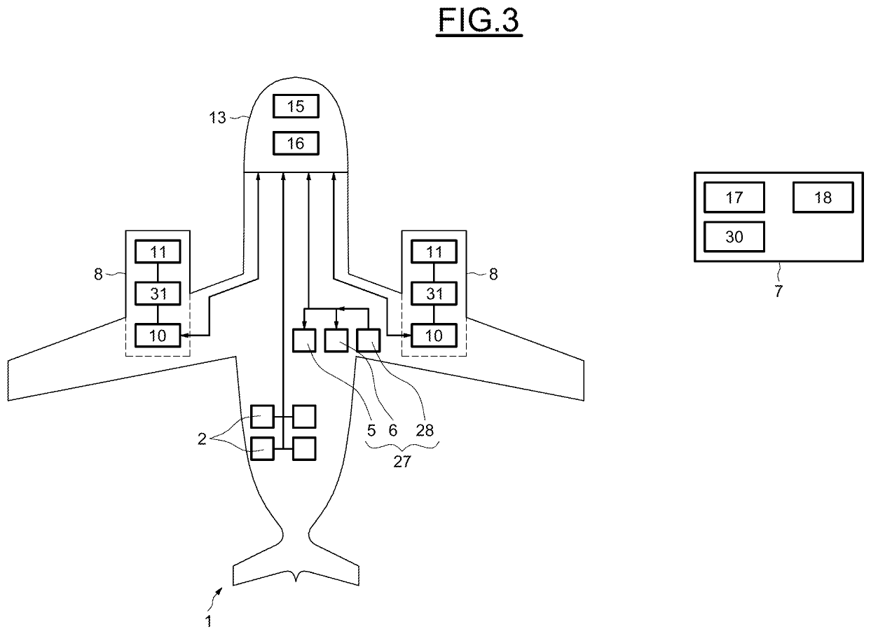

FIG. 3 shows another embodiment of an architecture for transmitting and collecting flight data according to the invention.

In this embodiment, the means for transmitting data reports are means 27 for bidirectional transmission of data and comprise units 28 for receiving and collecting messages coming from the station 7 for collecting data on the ground.

Moreover, the station 7 for collecting data on the ground comprises means 30 for sending a message to the units 28 for collecting messages of the aircraft 1 in order to request the reception of additional data from the aircraft. This device is also used to send requests for remote maintenance from the ground station.

In the embodiment of the invention visible in FIG. 3, the means 31 for transmitting the data of the engine bidirectionally transmits the data of the engine to the transmission means 27 of the aircraft 1, and vice versa.

In another embodiment of the invention, the means 31 for transmitting the engine data is a means 27 for transmitting the data report of the aircraft 1 and bidirectionally transmits the data reports or the messages of requests for sending additional data with the station 7 for collecting data on the ground.

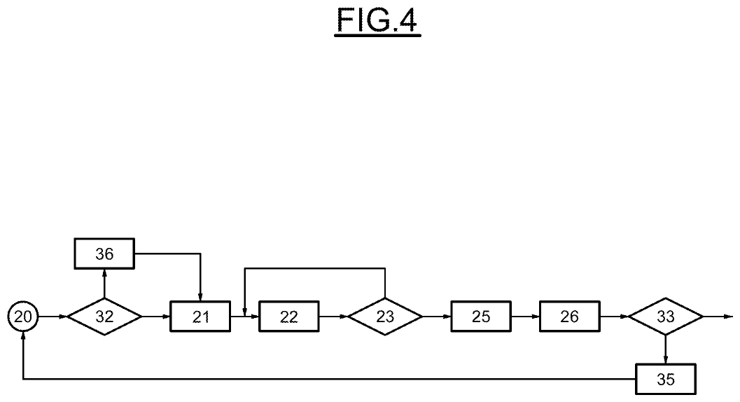

FIG. 4 shows the main steps of the method for collecting and transmitting a flight data report of an aircraft 1 for a bidirectional architecture. According to this architecture, the information is communicated from the aircraft to the station 7 on the ground and from the station on the ground to the aircraft 1.

First of all, as described above, the need for sending the data report, such as an ACARS report, is triggered by an event 20. This event is for example generated automatically, occurs after the presence of an anomaly or is initiated by a request from the station 7 for collecting data on the ground.

The method thus includes a first step 32 during which it is determined whether or not the event is initiated by the reception of a request for sending additional data.

If the event is initiated by the aircraft or the engine, the step 21 allows the acquisition and the recording of the data to be transmitted.

During the following step 22, the calculation of the cost index for each piece of data and for each available transmission means is carried out. The cost index is compared to threshold values (step 23).

If the cost index is lower than a threshold value and is considered to be favourable to sending, during the following step 25, this data report is transmitted to the station 7 on the ground. If this is not the case, the cost index is recalculated.

Finally, during the following step 26, the collection station on the ground receives the data, stores it and processes it.

During step 33, the collection station 7 on the ground determines whether the data corresponds to that which is expected or if it is necessary to request more data. In the latter case, during step 35, a request for sending of additional data from the aircraft is sent to the aircraft with the sending means 30, generating an event triggering the need to send a report. In this case, the event is identified as being initiated by a request from the ground station. During the following step 36, a verification of the request is carried out in order to know the content thereof and be able to then acquire the necessary data. This step 36 is also used to verify the integrity of the request.

1. Architecture for collecting and transmitting a flight data report of an aircraft comprising:
at least one data acquisition unit installed on board the aircraft;
means for transmitting the flight data report installed on board the aircraft; and
a station for collecting the flight data report on a ground, comprising:
means for calculating a cost index, and
a choice of a means for transmitting the flight data report and its content according to the value of the cost index.

2. The architecture according to claim 1, further comprising:
means for bidirectional transmission of data between engines of the aircraft.

3. The architecture according to claim 1, wherein the means for transmitting the data report are units configured to send the flight data report by various communication channels and protocols.

4. The architecture according to claim 1, wherein the aircraft further comprises a unit for collecting messages coming from the station for collecting data on the ground, wherein the station for collecting data on the ground comprises means for sending a message to the unit for collecting messages of the aircraft in order to ask to receive more data from the aircraft.

5. The architecture according to claim 1, wherein the cost index is determined on a basis of factors comprising:
a time of transmission of the data from the aircraft,
a cost of transmission of the data from the aircraft,
a contractual time remaining for making available the data of the aircraft, and
a gain associated with making available the data of the aircraft.

6. The architecture according to claim 1, wherein optimization of the choice of the means for transmitting the flight data report and its content involves avoiding redundancies of information and not being limited to predefined report formats.

7. Method for collecting and transmitting a flight data report of an aircraft comprising at least one data acquisition unit installed on board the aircraft, means for transmitting the flight data report installed on board the aircraft and a station for collecting the flight data report on a ground, comprising:
determining a calculation of a cost index for optimizing the choice of the means for transmitting the flight data report and its content according to the value of the cost index; and
sending, when necessary, the optimized data report from the aircraft to the station for collecting data on the ground.

8. The method according to claim 7, further comprising requesting sending of additional data from the aircraft, the request being received by a unit for collecting messages coming from the ground placed in the aircraft and the request coming from means for sending a message to the unit for collecting messages of the aircraft, means placed in the station for collecting data on the ground.

9. (canceled)

10. A non-transitory computer readable medium with computer executable instructions stored thereon, executed by a processor to perform the method according to claim 7.

11. The architecture according to claim 1, wherein the means for transmitting the flight data report are chosen from a satellite link and a Wi-Fi network.
